(19) United States
(12) Patent Application Publication
(10) Pub. No.: US 2012/0057473 A1
(43) Pub. Date: Mar. 8, 2012

(54) FAULT DIAGNOSTICS FOR IMPROVED QUALITY OF SERVICE

(75) Inventors: Quang Nguyen, Milpitas, CA (US); Henry Shi, Milpitas, CA (US); Robert Nino, Milpitas, CA (US); Patrick Sham, Milpitas, CA (US)

(73) Assignee: Public Wireless, Inc., San Jose, CA (US)

(21) Appl. No.: 13/224,049

(22) Filed: Sep. 1, 2011

Related U.S. Application Data
(60) Provisional application No. 61/379,679, filed on Sep. 2, 2010.

(51) Int. Cl. H04W 24/00

(52) U.S. Cl. 370/245

(57) ABSTRACT

Providing a near-carrier class service to a non-carrier class backhaul network, including: monitoring a connection of the non-carrier class backhaul network of at least one picocell by periodically sending at least one message to a monitoring agent located within an interne service provider network; tracing the connection to the monitoring agent through a network operations center when an acknowledgement in response to the at least one message is not received from the monitoring agent; generating an alert message that provides detailed information about a point of failure in the connection when a loss of connection is detected in tracing the connection; and generating a solution to fix the loss of connection so that the near-carrier class service can be provided to the non-carrier class backhaul network of the at least one picocell.

### CROSS-REFERENCE TO RELATED APPLICATIONS

This application claims the benefit of priority under 35 U.S.C. §119(e) of co-pending U.S. Provisional Patent Application No. 61/379,679, filed Sep. 2, 2010, entitled “Systems and Methods for Fault Diagnostics for Improved Quality Assurance.” The disclosures of the above-referenced application is incorporated herein by reference.

### BACKGROUND

1. Field of the Invention

The present application relates to the field of wireless communication systems, and more specifically, to systems and methods for providing improved quality of service.

2. Background

In a telecommunications network, the backhaul portion of the network comprises intermediate links between the core network and the sub-networks at the edge of the telecommunications network. Carrier class backhauls are extremely reliable network connections that provide 99.999% (“five nines”) availability, which means that the network is available 99.999% of the time with very few brief interruptions in service. Examples of carrier class connections include T1/E1, T3/E3, SONET and MetroEthernet. Service agreements for the “five nines” availability can be quite expensive.

### SUMMARY

Implementations of the present invention provide for diagnosing and addressing faults in a communication network to provide services that are near-carrier class on a less-than-carrier class backhaul.

In one implementation, a method of providing a near-carrier class service to a non-carrier class backhaul network is disclosed. The method includes: monitoring a connection of the non-carrier class backhaul network of at least one picocell by periodically sending at least one message to a monitoring agent located within an internet service provider network; tracing the connection to the monitoring agent through a network operations center when an acknowledgement in response to the at least one message is not received from the monitoring agent; generating an alert message that provides detailed information about a point of failure in the connection when a loss of connection is detected in tracing the connection; and generating a solution to fix the loss of connection so that the near-carrier class service can be provided to the non-carrier class backhaul network of the at least one picocell.

In another implementation, a method of providing a near-carrier class service to a non-carrier class backhaul network is disclosed. The method includes: receiving a connectivity alert message from at least one picocell providing detailed information about a point of failure in a connection for a backhaul network of the at least one picocell; determining whether an acknowledgement in response to the connectivity message has been received from a monitoring agent located within an internet service provider network; tracing the connection to the monitoring agent when the acknowledgement in response to the connectivity message has not been received from the monitoring agent; generating a solution to fix a loss of connection due to a failure in the point of failure so that a near-carrier class service can be provided to the non-carrier class backhaul network of the at least one picocell.

In a further implementation, a system of providing a near-carrier class service to a non-carrier class backhaul network is disclosed. The system includes: a controller to monitor a connection of a non-carrier class backhaul network of at least one picocell by periodically sending at least one message to a monitoring agent located within an internet service provider network, to trace the connection to the monitoring agent through a network operations center when an acknowledgement in response to the at least one message is not received from the monitoring agent, and to generate an alert message that provides detailed information about a point of failure in the connection when a loss of connection is detected in tracing the connection; and a backhaul unit to generate a solution to fix the loss of connection so that a near-carrier class service can be provided to the non-carrier class backhaul network of the at least one picocell.

### BRIEF DESCRIPTION OF THE DRAWINGS

FIG. 1 is a functional block diagram of a wireless communication network in accordance with one implementation of the present invention.

FIG. 2 is a functional block diagram of the logical or functional components of picocell in accordance with one implementation of the present invention.

FIG. 3 is a functional block diagram of ERDSS module according to one implementation of the present invention.

FIG. 4 is a functional block diagram of a portion of a communication network that can be used to implement the quality assurance monitoring techniques to provide a near-carrier class service on a non-carrier class backhaul.

FIG. 5 is a flow chart of a method for monitoring backhaul connectivity from a picocell (or a femtocell) according to one implementation of the present invention.

FIG. 6 is a flow chart of a method for monitoring backhaul connectivity from a monitoring agent at the cable headend of a cable network according to one implementation of the present invention.

FIG. 7 is a flow chart of a method for monitoring backhaul connectivity from a network operations center according to one implementation of the present invention.

FIG. 8 is a flow chart of another method for monitoring backhaul connectivity from a monitoring agent at the cable headend of a cable network according to one implementation of the present invention.

### DETAILED DESCRIPTION

Certain implementations as disclosed herein provide for diagnosing and addressing faults in a communication network to provide services that are near-carrier class on a less-than-carrier class backhaul. In one implementation, picocells (and/or femtocells) deployed in the field are enabled to use various types of non-carrier class backhauls, such as DSL, cable, fiber, or PSTN connections. These types of non-carrier class backhauls typically provide closer to 99.95% availability, but are significantly cheaper than carrier class connections.

After reading this description it will become apparent how to implement the present application in various alternative implementations and alternative applications. However, although various implementations of the present invention will be described herein, it is understood that these implementations are presented by way of example only, and not limitation. As such, this detailed description of various alternative implementations should not be construed to limit the scope or breadth of the present application.

In one implementation, the techniques described herein are used to help pinpoint which node in the backhaul network is faulty, and generate an alert to the network provider that indicates where the error has occurred. By providing detailed information, the network provider is able to more quickly address the problem to increase the availability of the backhaul network connection. Further, these techniques are used to provide real-time monitoring of the network providing the backhaul to the picocell. The monitoring improves the level of service of the non-carrier class backhauls to be as close as possible to carrier class service.

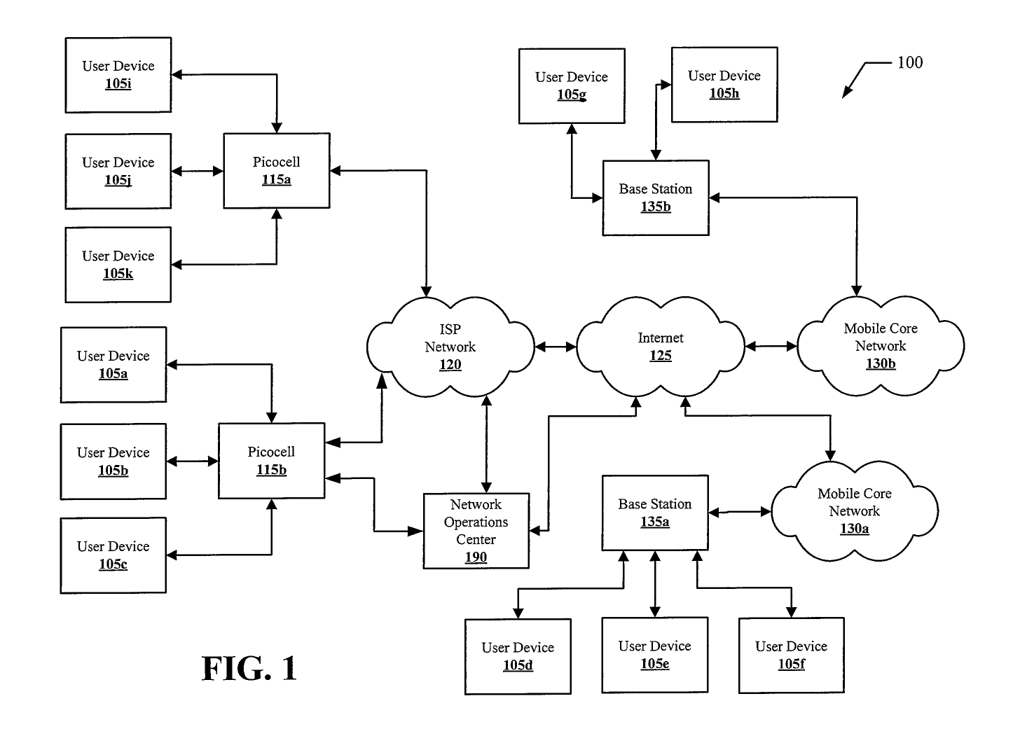

FIG. 1 is a functional block diagram of a wireless communication network 100 in accordance with one implementation of the present invention. Picocells 115a and 115b are deployed to provide coverage for one or more wireless user devices 105a, 105b, 105c, 105i, 105j, 105k. Picocells 115a and 115b are configured as small base stations that can be deployed to provide coverage for a smaller area than a typical base station coverage. For example, a picocell can provide coverage for an office building, hotel, condominium complex, shopping mall, airport, train station, or event venue. Picocells can be used to fill in coverage in indoor environments where signals from outdoor conventional base stations do not easily reach. Picocells can also be used to add network capacity in areas where dense mobile device usage can be present, such as airports, train stations, and sports or concert venues.

While the implementation illustrated in FIG. 1 includes two picocells, other implementations can include one or more picocells. Furthermore, while the implementations described herein are described with respect to backhaul connections for picocells, one skilled in the art will also recognize that the techniques described herein can also be applied to backhaul connections for femtocells.

Picocells 115a and 115b provide coverage for one or more mobile network providers and/or phone carriers. In one implementation, picocells 115a and 115b communicate with the mobile core networks 130a, 130b of the mobile phone carriers via a connection provided by an Internet Service Provider (ISP) network 120. In one embodiment, the mobile core networks employ radio access network (RAN). The ISP network 120 provides backhaul connections for picocells 115a, 115b. In the illustrated implementation of FIG. 1, the ISP network 120 communicates with the core networks 130a, 130b indirectly via the Internet 125. In another implementation, the ISP network 120 communicates with the core networks 130a, 130b directly. Core networks 130a, 130b provide telecommunication services to the user devices 105a, 105b, 105c, 105d, 105e, 105f, 105g, 105h, 105i, 105j, 105k (collectively referred to as “105”) that are subscribers of the respective network provider associated with the core networks 130a, 130b. User devices 105 can be a mobile communication device, such as a mobile phone or wireless modem, or other device using voice and/or data communications services of the core networks 130a, 130b.

Picocells 115a and 115b can receive the data from the core networks 130a, 130b via the ISP network 120 and transmit the data to one or more user devices 105a, 105b, 105c, 105i, 105j, 105k. Picocells 115a and 115b can also receive voice and/or data packets from the user devices 105a, 105b, 105c, 105i, 105j, 105k.

As described above, the picocells 115a and 115b can be contracted with one or more mobile network providers to provide coverage for user devices 105 associated with those carriers. At least some of the user devices 105 that enter the coverage area of the picocells 115a and 115b are associated with other carriers and communicate using a different frequency than that normally used by the picocells 115a, 115b when communicating with the user device 105 associated with the carriers with which the picocells 115a, 115b are contracted to provide coverage.

The picocells 115a, 115b can include one or more radio devices that can be remotely configured by a network administrator to operate using different frequencies and/or communication protocols. In some implementations, the radio devices of the picocells can be reconfigured based on demand. Furthermore, the picocells can include radio device beyond what is forecast for current coverage needs to allow the picocells to expand to provide service to a larger number of subscribers and/or carriers in the future and to provide additional radio devices that can be activated in the future if internal monitoring systems implemented into the picocells detect that radio device(s) has failed. By providing reconfigurable radio devices and radio devices in excess of projected near term requirements, significant cost savings can be realized by reducing the number of times that a technician needs to be deployed to the field to service the picocells. Remote monitoring allows system administrators to identify problems early, and attempt to correct the problem remotely. Should an error not be correctable remotely, the systems administrators can schedule a technician to service the device and order a replacement device that can be assembled and shipped to the technician in advance since the fault has been diagnosed and isolated to particular device(s) or connection(s). The technician can simply replace the faulty device with the new device and ship the faulty device back to the maintenance center for refurbishment. This approach can significantly reduce the amount of time that the technicians need to be deployed at the picocell sites since they do not have to diagnose problems in the field. This approach can also reduce expenses by reducing the need for the technicians to have expensive diagnostic equipment and replacement parts out in the field.

The coverage area of the picocells 115a, 115b can also overlap the coverage areas of one or more base stations 135a, 135b. The base stations 135a, 135b are in communication with the mobile core networks 130a, 130b, respectively, and provide coverage to user devices 105d, 105e, 105f, 105g, 105h.

Network operations center (NOC) 190 comprises one or more computing centers for managing the operation of the picocells 115a, 115b in the field. In some implementations, the NOC 190 can manage the operation of an entire network of picocells installed across a wide geographical area. In other implementations, the network can include a mix of different types of base stations, picocells, and femtocells.

The NOC 190 enables a system administrator or technician to remotely monitor the operation of picocells 115a, 115b and other base stations on the network, and to remotely configure or reconfigure the picocells 115a, 115b. Although the reconfiguration (to configure or reconfigure) is done in the event that a problem is identified that can be corrected by reconfiguring the picocells 115a, 115b, the reconfiguration can be done even when there is no problem with the picocells 115a, 115b. For example, the reconfiguration can be done to adjust the coverage period or duration.

If a problem is identified at the picocells 115a, 115b, and the reconfiguration does not solve the problem, a system administrator can schedule a service technician to visit the picocells 115a, 115b in the field and preorder the replacement components needed to correct the problem before the technician is dispatched. In some implementations, in order to decrease service costs and the number and length of visits to picocells deployed in the field, a replacement picocell matching the requirements of a malfunctioning picocells can be ordered and shipped to the technician in advance of the visit to the site. In other implementations, the entire picocells can be replaced by the technician and sent back to a central service facility for refurbishment. The refurbished picocells can then be used in a future installation. This approach can result in significant cost savings, because technicians can be trained to quickly replace the entire device in the field. Technicians do not have to spend significant amounts of time trying to diagnose a malfunctioning piece of equipment in the field, and each of the technicians deployed in the field do not require expensive diagnostic equipment and an extensive supply of spare parts.

The system administrators can monitor the network or networks providing backhaul connectivity to the picocells 115a, 115b and troubleshoot network problems. In the event that a problem occurs in a portion of the network managed from the NOC 190, a technician can be dispatched to correct the problem. In the event that a problem is detected in a portion of the network managed by a third party network provider, such as an ISP network provider, a work order can be sent to that third party network provider which identifies the failed component.

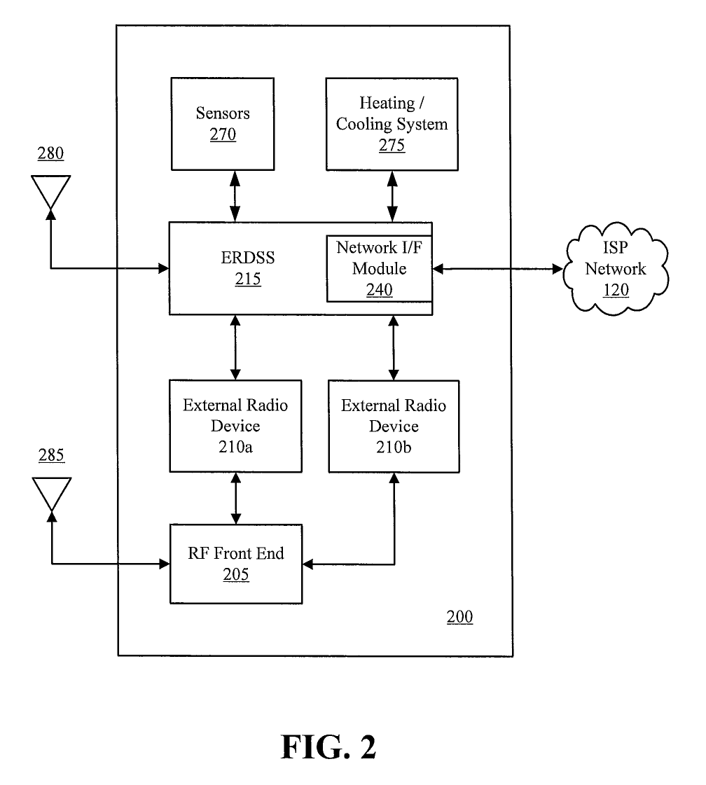

FIG. 2 is a functional block diagram of the logical or functional components of picocell 200 in accordance with one implementation of the present invention. The picocell 200 is configured substantially similar to the picocells 115a, 115b, and includes RF front end module 205, external radio devices (ERDs) 210a, 210b, External Radio Device Support System (ERDSS) module 215, and network interface module 240. The picocell 200 also includes sensors 270 and heating/cooling system 275 that interface with the ERDSS module 215. The functions of the sensors 270 and the heating/cooling system 275 are described in further detail below. The ERDs 210a, 210b are responsible for establishing a wireless link between the picocell 200 and one or more user devices 105, and receives data to be transmitted to the user device 105 via the ERDSS module 215.

The ERDs 210a, 210b can comprise software-defined radios (SDRs) for communicating wirelessly with the user devices 105. The ERDs 210a, 210b can send data and/or voice packets received by the picocell 200 via the ISP network 120 to the user devices 105 using antennas 280, 285. The ERDs 210a, 210b can also receive voice and/or data packets from the user devices 105. The SDR is a programmable radio device that includes a processor for executing signal processing. The SDR receives and transmits using a variety of different radio protocols (waveforms) based on the software that is executed by the processor. The SDR can be reconfigured to change radio protocols and/or frequencies at which the SDR operates in real-time.

The RF front end module 205 provides an interface between the ERDs 210a and 210b and the antenna 285. Antenna 285 can comprise one or more antenna elements. The RF front end module 205 can comprise power amplifiers for driving the antenna 285, low noise amplifiers (LNAs) for amplifying signals captured by antenna 285, and can implement various filters for conditioning signals received from the antenna 285 and/or from the ERDs 210a and 210b.

The RF front end module 205 combines and splits the RF signals for implementations where the picocell 200 includes multiple antennas. For example, the ERD 210a includes two receive chains supporting diversity combining.

One or more antennas 280, 285 can comprise a broadband antenna that is optimized for transmitting and/or receiving in the frequency bands that are typically used for mobile communications.

Network interface module 240 is a component of the ERDSS module 215 and provides an interface between a broadband connection to the ISP network 120 and the picocell 200. This connection provides a backhaul for the picocell 200. The network interface module 240 can send voice and/or data packets across ISP network 120 to the mobile core networks 130a, 130b, the Internet 125, and/or to other destinations connected to the ISP network 120. The network interface module 240 can also receive voice and/or data packets from the network 120. As described above, the picocell 200 can include multiple ERDs, and each ERD can use a particular mobile carrier. The ERDs can be reconfigured for use with different mobile carriers based on demand.

The ERDSS module 215 provides an interface to the backhaul of the picocell 200. The ERDSS module 215 operates with various types of backhaul connections to the ISP network 120. For example, the ERDSS module 215 operates with Data Over Cable Service Interface Specification (DOCSIS) connections, Asymmetric Digital Subscriber Line (ADSL) connections, Very-high-bit rate DSL (VDSL), Digital signal 1 (T1), or optical fiber connections. In some implementations, the ERDSS module 215 also uses a satellite backhaul.

The ERDSS module 215 can also provide power distribution and control, environmental monitoring, and local and remote system management support for the picocell. For example, an administrator or technician remotely monitors the operating status of the picocell, sends configuration commands and/or updated software to the ERDSS module 215 to remotely modify the operation of the ERDSS module 215 without requiring a technician to visit the picocell 200 in the field to check the status of the device, maintains the device, or reconfigures the device. In some implementations, the picocell 200 includes more ERDs than are needed to provide service according to the contracts with the carriers. The additional ERDs can provide failover protection in the event that ERD(s) fails. The ERDSS module 215 can disable the faulty ERD and configure one or more of the extra ERDs to take over for the faulty ERD. This can provide a significant cost savings by substantially reducing the need for a service technician to visit the picocell 200 to service the device. The ERDSS module 215 can send an alert message to the NOC 190 that an ERD has failed and whether another ERD was successfully configured to take the place of the failed ERD. In other implementations, the ERDSS module 215 configures an ERD to handle excess traffic during high utilization periods if the picocell 200 includes available ERD(s).

In some implementations, the picocell 200 includes a heating/cooling system (HCS) 275. The picocell 200 can be installed in harsh conditions with extremely high or low temperature and/or humidity that could adversely affect the operation of the picocell 200. The HCS 275 provides heating and/or cooling to maintain the temperature of the device 200 within a preferred operating range. The HCS 275 also dehumidifies the air where humidity levels exceed preferred operating thresholds.

The picocell 200 can also include one or more sensors 270 that can collect environmental information, such as temperature and humidity levels in the picocell 200. Other types of sensors, such as an accelerometer can also be included to determine whether the picocell 200 is being subjected to vibrations or impact. For example, the accelerometer could be used to determine whether a picocell mounted on a utility pole or other outside area is being subjected to high winds.

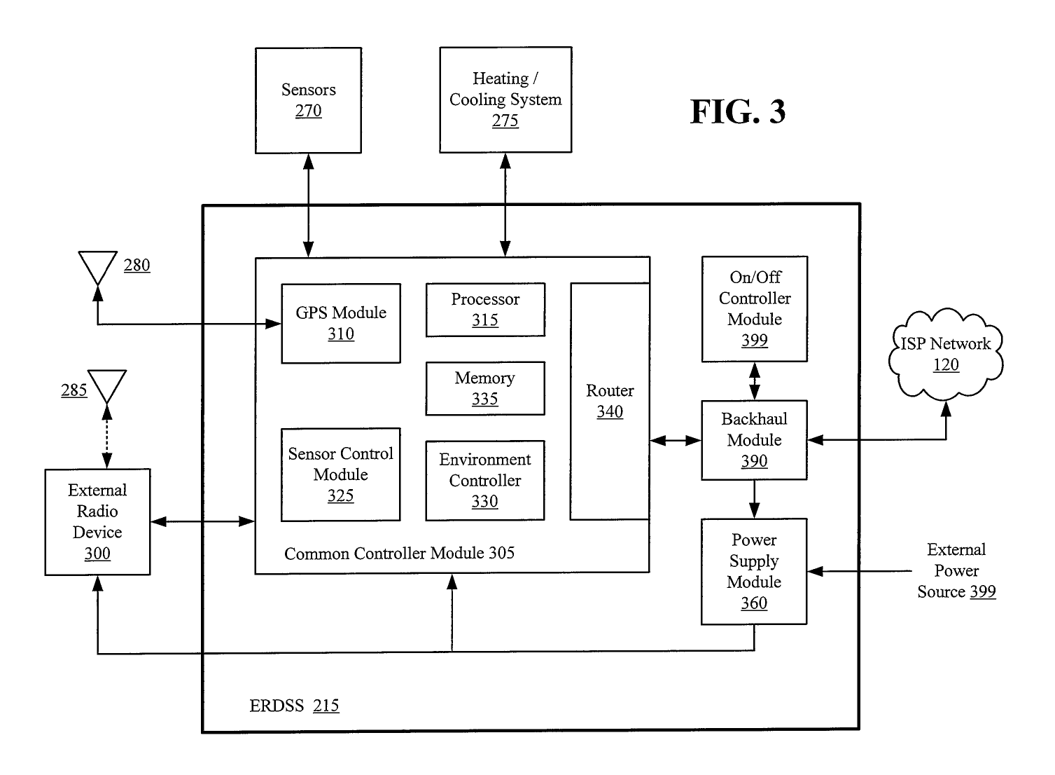

FIG. 3 is a functional block diagram of the logical or functional components of ERDSS module 215 according to one implementation of the present invention. The ERDSS module 215 includes common control module 305, power supply module 360, backhaul module 390, and On/Off controller module 380. The ERDSS module 215 is connected to the ISP network 120 via the backhaul module 390. The ERDSS module 215 is also connected to ERD 300, which is configured substantially similar to the ERDs 210a, 210b. In one implementation, the network interface module 240 of FIG. 2 can comprise the backhaul module 390 illustrated in FIG. 3. In another implementation, the functions of the ERDSS module 215 can be performed by the backhaul module 390.

The backhaul module 390 is configured for backhauling mobile device's data received via the ERD 300 to the subscribed mobile carrier's core network 130. The backhaul module 390 also forwards data from the subscribed mobile carrier's core network 130 to the ERD 300. The backhaul module 390 further includes various types of data connections to the ISP network 120. For example, some implementations can use Data Over Cable Service Interface Specification (DOCSIS) connections, digital subscriber line (DSL) connections, Asymmetric Digital Subscriber Line (ADSL) connections, Very-high-bit rate DSL (VDSL) connections, Digital signal 1 (T1), optical fiber connections, or other types of broadband connections. In some implementations, the ERDSS module 215 uses a satellite backhaul connection. In one implementation, the backhaul module 390 supports backhaul fault and performance monitoring, including Carrier Ethernet grade one-way frame delay measurement, connectivity fault management and fault isolation per ITU-T Y.1731 and other Carrier grade Ethernet standards and proprietary methods.

In the illustrated implementation of FIG. 3, the common controller module (CCM) 305 comprises a processor 315, memory 335, router 340, environment controller module 330, sensor control module 325, and GPS module 310. The processor 315 executes programmable code stored in the memory 335. The memory 335 is a non-transitory, computer-readable medium, and can comprise persistent memory, such as flash memory, volatile memory, such as random access memory, or a combination thereof. Other types of persistent and/or volatile memory can be used. In one implementation, the ERDSS module 215 is programmed remotely by updating the executable program code stored in the memory 335. The code can be remotely updated from the NOC 190 via the backhaul connection to the ERDSS module 215. Further, the CCM 305 communicates with the NOC 190 using in-band or out-of-band communications.

In one implementation, the CCM 305 is responsible for managing the operation of the ERDSS module 215. The CCM 305 can be programmed to configure the various functional units of the system including the power supply module 360 and the backhaul module 390. The CCM 305 provides for local and remote maintenance of the ERDSS module 215 and controls the power supply to the ERDSS module 215 via the power supply module 360. The core of the CCM 305 is configured to be independent of the type of backhaul interface so that the CCM 305 can work with any type of backhaul interface used to connect the ERDSS module 215 to the ISP network 120. The core of the CCM 305 is also configured to be independent of the type of radio interface so that it can work with any type of radio interface used to allow the ERDSS module 215 to be flexible. In another implementation, the CCM 305 provides synchronization of the backhaul traffic, jitter buffering, stack jitter control, and derive precise frequency and timing from an IEEE 1588 traffic flow.

In some implementations, the ERDSS module 215 is modular such that one or more ERD 300 of the same or varying configuration can be plugged into the ERDSS module 215. In other implementations, the backhaul module 390 and the power supply module 360 can be modular so that any appropriate backhaul module 390 and the power supply module 360 can be plugged into the ERDSS module 215 based on the type of backhaul and type of power supply to be used.

In the illustrated implementation of FIG. 3, the GPS module 310 is coupled to GPS antenna 280. Thus, the GPS module 310 can provide location data for the ERDSS module 215. In one implementation, the ERDSS module 215 provides the location information obtained from the GPS module 310 to the NOC 190 so that the technicians can remotely confirm the location of the picocell 200. For example, the location information can be used to confirm that the picocell 200 has been installed at the correct location, to confirm whether picocell 200 is still installed at the correct locations, and to facilitate field technician in locating the picocell 200 should physical visit to the picocell be required for maintenance or upgrade. In some implementations, the ERDSS module 215 configures itself by utilizing the GPS location and a NOC database to obtain configuration information for site-specific operating parameters, such as RF frequency, signal strength, and other parameters. This can allow for more efficient deployment of the picocells. The GPS module 310 can also provide timing information to the ERDSS module 215 in addition to location information. This timing information can include data and time information and can be used for wireless communication synchronization.

The sensor control module 325 receives and processes signal data from the various sensors 270 of the picocell 200. In some implementations, the CCM 305 provides ports or other data interfaces that allow the CCM 305 to interface with various types of sensors, and the sensor control module 325 operates the various sensors interfaced with the ERDSS module 215.

The environment controller module 330 receives environmental sensor data from the sensor control module 325, analyzes the environmental sensor data, and sends control signals to the HCS 275 to cause the HCS 275 to heat or cool the picocell 200 if the temperature range of the picocell 200 has risen above or fallen below a preferred operating range for the device.

The router 340 can receive packet data from the backhaul module 390 and provide packet data from the CCM 305 to the backhaul module 390 for transmission across the backhaul connection. The CCM 305 packetizes data received from the external radio device 210 to facilitate transmission of the data from the backhaul, and reconfigures the packetize data received from the backhaul via the router 340 to a data format expected by the ERD 300. In some implementations, data packets from/to the ERD 300 are received/sent by the router 340 and transported directly to the ISP network 120 via the backhaul module 390. In other implementations, data packets from/to an ERD 300 are received/sent by the CCM 305 before being transported to the ISP via the backhaul module 390. Furthermore, it is also possible that both approaches are utilized simultaneously in the same picocell based on network requirements, traffic types, or other considerations. The router 340 can direct traffic from any port to any other port based on source and destination address.

The router 340 performs “quality of service” (QoS) functions that can include classifying, queuing, prioritizing, sending or dropping packets based on service level requirements (throughput, latency, jitter). The router 340 also assigns private IP address to ERDs and do public to private Internet Protocol (IP) address translation to simplify interface with backhaul ISP. For example, only one public IP address would be needed for whole picocell 200 regardless of the number of ERDs 210a, 210b. Further, the router 340 operates in a transparent switch mode where each ERD 300 can be assigned a separate network address. The router 340 also performs deep traffic inspection and processing, such as splitting voice and data into separate data streams and performing traffic optimization.

The backhaul module 390 passes configuration and management information to the ERD 300. For example, the ERD 300 can be configurable to operate over a wide range of frequencies and using various communications protocols. In one implementation, the ERD 300 can be configured to a default configuration at the time that the picocell 200 is manufactured or deployed in the field. In another implementation, the ERD 300 can be configured and/or reconfigured remotely by an administrator at the NOC 190.

One or more ERD 300 included in the picocell 200 can be reconfigured on the fly based on contractual agreements with the carriers and/or based on current or projected demand from user devices within the coverage area of the picocell 200. The ERD 300 can receive power from the power supply module 360 of the ERDSS module 215. In one implementation, each ERD 210 provides a standard output that can be processed by the ERDSS module 215 regardless of the operating configuration of the ERD 300. For example, the ERD 300 outputs IP packets to the ERDSS module 215 regardless of the configuration of the ERD 300. This allows the ERDSS module 215 to operate with a wide variety of different types of ERD configurations.

The backhaul interface can provide both backhaul data and power, and the backhaul module 390 can provide power to the power supply module 360. For example, where the backhaul connection of the ISP network 120 comprises a CATV connection, the CATV connection can provide both data connectivity and power to the ERDSS module 215. When the backhaul connection provides both data connectivity and power, the backhaul module 390 extracts the data signal from the backhaul connection and gates extracted power to the power supply module 360.

The power supply module 360 supplies power to the rest of the ERDSS module 215 and to provide power to the ERD 300. The input power supply is highly dependent upon the locality of the CCM 305, and the power supply module 360 receives power inputs from various sources. For example, the power supply module 360 receives 120 or 240 volt AC power available from power lines, or receives power from a CATV power plant via a cable TV connection, or other power source depending upon the location and of the picocell 200. For example, the picocell 200 is mounted on the messenger strand cable running between utility poles and is connected to a cable CATV cable for backhaul and power.

In some implementations, the power supply module 360 includes an uninterruptible power supply (UPS) for providing backup power for a short period of time in the event that the primary power source to the ERDSS module 215 fails. In one implementation, the power supply module 360 can include one or more rechargeable batteries that can be kept charged by the power supply module 360 while the primary power source is available and that can be used as a backup power source if power from the primary power source is interrupted. In other implementations, the power supply module 360 corrects some common problems with power supplied from an external power supply. The problems comprise a power surge where a momentary or sustained increase in main voltage occurs, sag where a momentary or sustained decrease in main voltage occurs, spikes where brief high voltage transients occur (such as due to lightning strike, short circuits, power transitions in large equipment on the same line, electromagnetic pulses (EMP) and inductive spikes), noise (e.g., high frequency transient or oscillation usually injected into the line by nearby equipment), frequency instability resulting from temporary changes in the mains frequency, or harmonic distortion caused by a departure from the ideal sinusoidal waveform expected on the line.

In some implementations, the ERDSS module 215 periodically pings the NOC 190 or vice versa to confirm that the network links along the backhaul are working and that the ERDSS module 215 is responding. If the NOC 190 notices that a ping from the ERDSS module 215 has not been received recently or that a ping to the ERDSS module 215 has not been successful, a network link investigation process can be initiated in an attempt to determine whether there is a bad link in the network or whether the ERDSS module 215 or the picocell 200 is offline. The ERDSS module 215 pings mobile core network 130 to determine if the radio voice and data traffic path is healthy and report the result to the NOC 190. If the network connection between the ERDSS module 215 and the NOC 190 is temporarily down, the ERDSS module 215 continues pinging mobile core network 130, to store the results in its memory 335, and to send the accumulated results back to the NOC 190 once network connectivity to the NOC 190 is restored.

The On/Off controller module 380 turns on or off components of the ERDSS module 215, including powering on or off the ERDSS module 215 itself. In one implementation, the on/off controller module 380 receives remote instructions from the NOC 190 over the backhaul connection via the backhaul module 390. These instructions can be used by the on/off controller module 380 to power on or off one or more of the ERD 300, HCS 275, sensors 270, ERDSS module 215 itself, or other components of the ERDSS module 215. In another implementation, if the ERDSS module 215 powers down, the backhaul module 390 and the on/off controller module 380 remains powered on to monitor the backhaul connection for instructions from the NOC 190 to power up the ERDSS module 215.

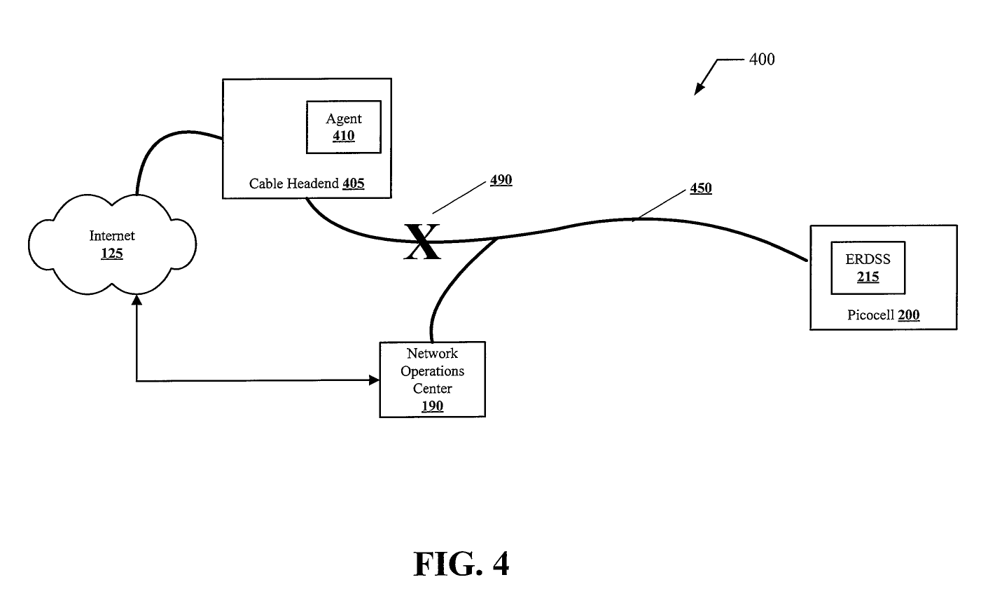

FIG. 4 is a functional block diagram of the logical or functional components of a portion of a communication network 400 that can be used to implement the quality assurance monitoring techniques to provide a near-carrier class service on a non-carrier class backhaul. In the illustrated implementation of FIG. 4, the ISP network 120 is implemented on a cable television network (represented partially in FIG. 4 as cable headend 405). Thus, the picocell 200 uses a broadband connection over the cable television network to provide the backhaul connection to the Internet 125 and to the mobile core networks 130 (see FIG. 1) via the Internet 125.

Connection 450 illustrates a logical network connection from the picocell 200 to the cable headend 405 of the cable network, and can comprise one or more physical network connections within the ISP network 120. Further, the principles, methods and systems described in connection with the cable television network can be applied to other types of networks.

In the illustrated implementation of FIG. 4, the cable headend 405 includes a monitoring agent 410. The monitoring agent 410 communicates with the ERDSS module 215 of the picocell 200 and the NOC 190 to facilitate monitoring of the network connection 450 between the picocell 200 and the cable headend 405. The monitoring agent 410 can help to diagnose problems in the network and the information collected can be sent to the network provider to alert the provider that a particular network node is down.

The ERDSS module 215 of the picocell 200 monitors network connectivity along the backhaul connection. The ERDSS module 215 can take action if network connectivity along the backhaul is lost due to a faulty component in the network or a break 490 in a network cable. For example, the ERDSS module 215 can send a message to the NOC 190 if the backhaul connection to the picocells 200 is lost.

In the illustrated implementation of FIG. 4, the break 490 in the connection has occurred upstream from the point where the NOC 190 and the picocell 200 are connected to the cable network so that the NOC 190 and the ERDSS module 215 are still able to communicate with each other. In this case, the ERDSS module 215 can send a message to the NOC 190, and the NOC 190 can send a message to the monitoring agent 410 located at the cable headend 405 (via the Internet 125) in an attempt to identify where the fault in the cable has occurred. If the NOC 190 is able to receive the message from the ERDSS module 215, then the network node that has gone down is upstream from the point where the NOC 190 is connected to the cable network. This removes part of the network connection 450 as the source of the problem, and can help to narrow down the actual point of failure so that the proper fault isolation can be performed.

In the illustrated implementation of FIG. 4, the NOC 190 has a connection to the Internet 125 and can send a message to the monitoring agent 410 via the Internet 125 to determine whether the monitoring agent 410 can be reached. In some implementations, the ERDSS module 215 (e.g., the backhaul module 390 can implement this function) can send a message to the monitoring agent 410 to determine whether the monitoring agent 410 can be reached, and if no response is received from the monitoring agent 410, the ERDSS module 215 can then send a message to the NOC 190. The ERDSS module 215 can execute a trace route in an attempt to identify which network node has gone down.

The monitoring agent 410 actively monitors the network connectivity for one or more picocells deployed on the cable network, and periodically sends a message to the ERDSS module 215 to determine whether the ERDSS module 215 can be reached. The ERDSS module 215 (e.g., the backhaul module 390) then sends an acknowledgement message to the monitoring agent 410. If the monitoring agent 410 does not receive a response from the ERDSS module 215, the monitoring agent 410 can send a message to the NOC 190 to report a problem. At this point, the monitoring agent 410 can execute a trace route to help determine where the problem in the network has occurred. The monitoring agent 410 receives an alert message from the NOC 190 in the event that the backhaul connection to the picocell 200 goes down. In response, the monitoring agent 410 performs a trace route in an attempt to identify a network node that has failed.

The information collected by the NOC 190, the monitoring agent 410, and/or the ERDSS module 215 is used to generate an alert message that provides detailed information about the point of failure in the network. Providing this detailed information in the alert message substantially reduces the need for the network provider to identify the source of the problem, and results in the problem being fixed more quickly than merely lodging a general complaint with the network provider that the network connection to the picocell 200 has failed. The NOC 190 and the monitoring agent 140 use connectivity information for a plurality of picocells 200 to determine the exact point of failure in the network by examining which picocells have connectivity and which picocells have lost connectivity.

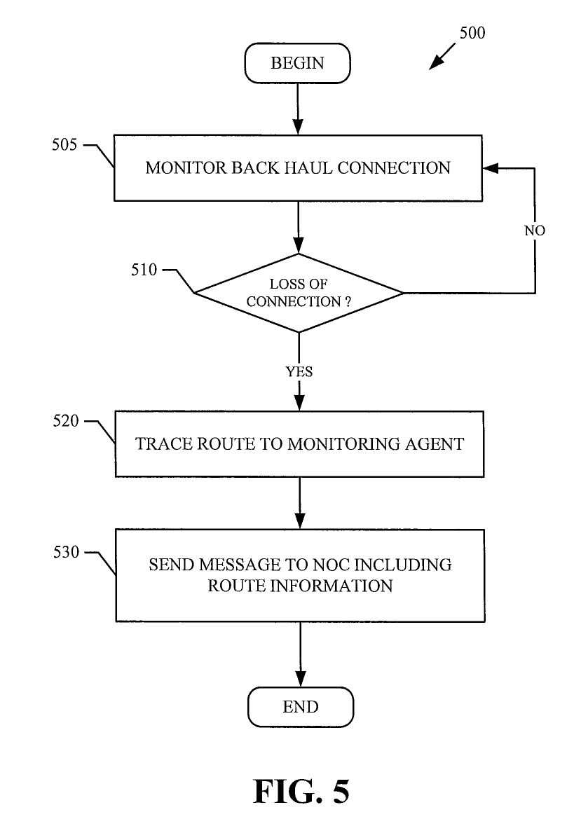

FIG. 5 is a flow chart 500 of a method for monitoring backhaul connectivity from a picocell (or a femtocell) according to one implementation of the present invention. At box 505, the ERDSS module 215 of the picocell 200 monitors network connectivity across the backhaul, and determines if a loss of network connectivity is detected, at box 510. In one implementation, the ERDSS module 215 of the picocell 200 periodically sends a message to the monitoring agent 410 and receives an acknowledgement in response to the message if the monitoring agent 410 receives the message. In another implementation, the ERDSS module 215 periodically pings the monitoring agent 410 to determine whether a connection to the cable headend 405 is available.

If the ERDSS module 215 of the picocell 200 detects a loss of connectivity, at box 510, the ERDSS module 215 executes a trace route to the monitoring agent 410, at box 520, in an attempt to identify the failure point in the network so that the detailed information is provided to the network provider. The ERDSS module 215 then sends an alert message to the NOC 190, at box 530, that includes the trace route information so that the NOC 190 can contact the network service provider and report the problem.

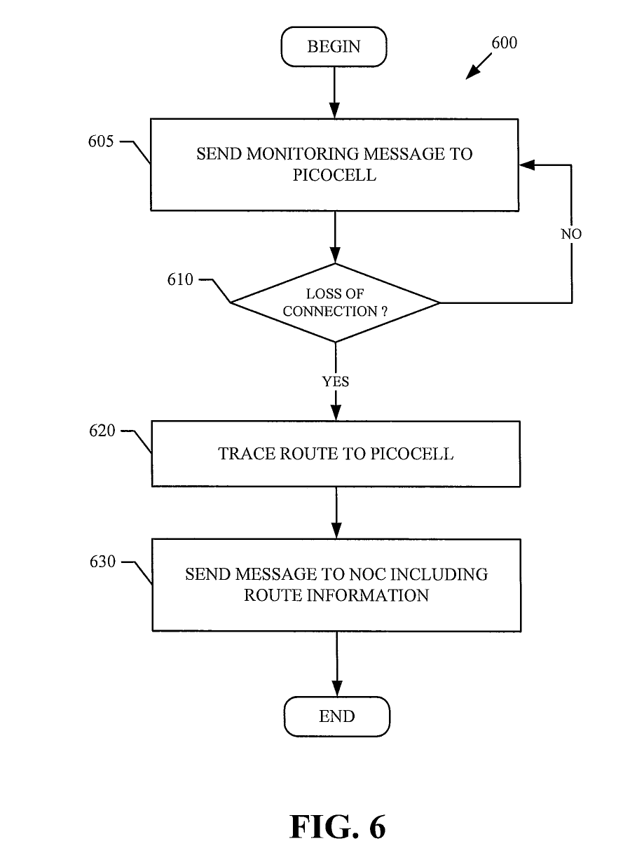

FIG. 6 is a flow chart 600 of a method for monitoring backhaul connectivity from a monitoring agent at the cable headend of a cable network according to one implementation of the present invention. The monitoring agent 410 monitors network connectivity across the backhaul to the picocell 200, at box 605, and determines if a loss of network connectivity is detected, at box 610. In one implementation, the monitoring agent 410 periodically sends a monitoring message to the picocell 200 and receives back an acknowledgement in response to the message if the connection to the picocell is available. In another implementation, the monitoring agent 410 periodically pings the picocell 200 to determine whether a connection from the cable headend 405 to the picocell 200 is available.

If the monitoring agent 410 detects a loss of connectivity to the picocell 200, at box 610, the monitoring agent 410 executes a trace route to the picocell 200, at box 620, in an attempt to identify the failure point in the network so that detailed information can be provided to the network provider. The monitoring agent 410 then sends an alert message to the NOC 190, at box 630, that includes the trace route information so that the NOC 190 can contact the network service provider and report the problem.

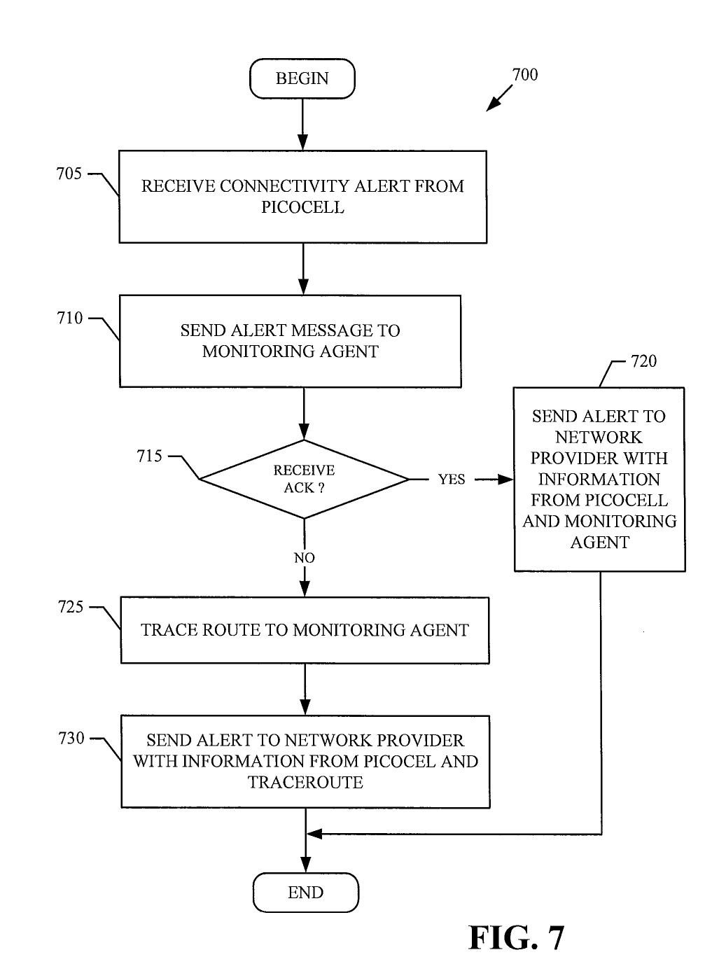

FIG. 7 is a flow chart 700 of a method for monitoring backhaul connectivity from a network operations center according to one implementation of the present invention. The NOC 190 receives a connectivity alert message from the ERDSS module 215 of the picocell 200, at box 705, if the picocell detects a loss of backhaul connectivity. The connectivity alert message includes trace route information from the picocell 200 to the monitoring agent 410 that identifies a point of failure along the network. The NOC 190 then optionally sends a connectivity alert message to the monitoring agent 410, at box 710, indicating that the picocell 225 has reported a loss of connectivity. At box 715, the NOC 190 determine whether a response to the alert message has been received from the monitoring agent 410. The response from the monitoring agent 410 includes trace route information that identifies a point of failure along the network between the monitoring agent 410 and the picocell 200.

If a response is received from the monitoring agent 410, at box 715, the NOC 190 sends an alert message to the network provider, at box 720, that includes the information received from the picocell 200 and the monitoring agent 410. This information is used to pinpoint where along the network the problem has occurred and helps the network provider to address the problem more quickly.

If no response is received from the monitoring agent 410, at box 715, the NOC 190 optionally executes a trace route to the monitoring agent 410, at box 725, to determine whether a network node between the NOC 190 and the monitoring agent 410 has failed. The NOC 190 can then send an alert message to the network provider, at box 730, that includes the information received from the picocell 200 and the trace route information sent to the monitoring agent 410.

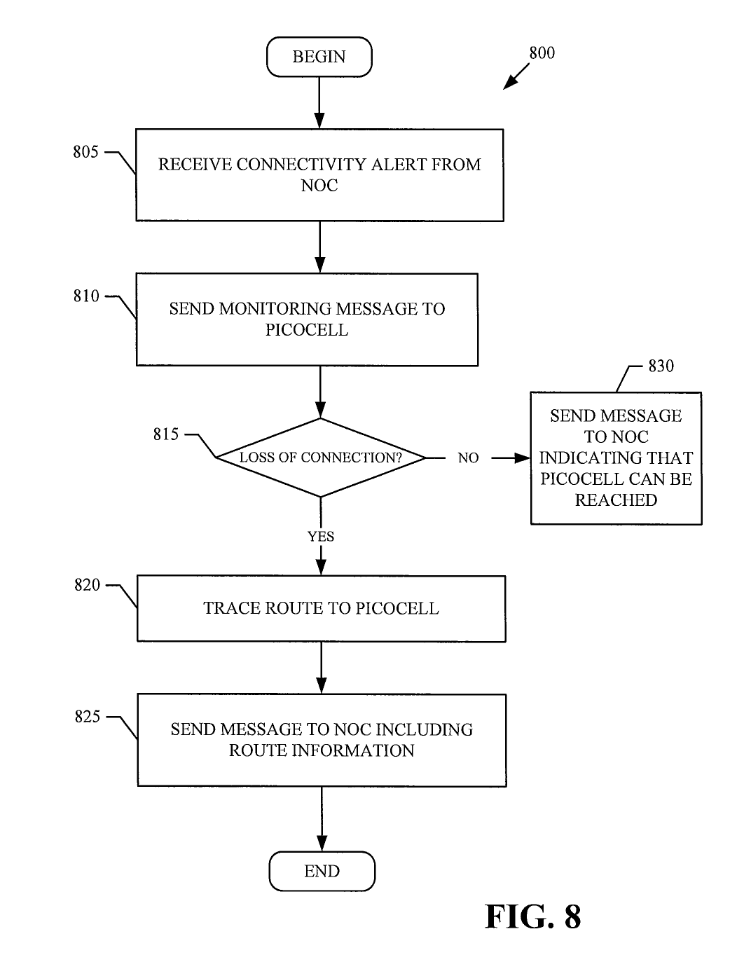

FIG. 8 is a flow chart 800 of another method for monitoring backhaul connectivity from a monitoring agent at the cable headend of a cable network according to one implementation of the present invention. At box 805, the monitoring agent 410 receive a connectivity alert message from the NOC 190 that the picocell 200 has reported a loss of connectivity. The monitoring agent 410 sends a monitoring message to the picocell 200, at box 810, to determine whether the monitoring agent 410 can reach the picocell 200 from the cable headend. In one implementation, the monitoring agent 410 periodically pings the picocell 200 to determine whether a connection from the cable headend 405 to the picocell 200 is available.

If the monitoring agent 410 detects a loss of connectivity to the picocell 200, at box 815, the monitoring agent 410 executes a trace route to the picocell 200, at box 820, to identify the failure point in the network so that detailed information can be provided to the network provider. The monitoring agent 410 then sends an alert message to the NOC 190, at box 825, that includes the trace route information so that the NOC 190 can contact the network service provider and report the problem. Otherwise, if connectivity from the monitoring agent 410 at the cable headend to the picocell 200 is not lost (determined at box 815), the monitoring agent 410 sends a message to the NOC 190, at box 830, that a network connection to the picocell 200 is available and can be reached.

Accordingly, the techniques described above are used to improve the level of service of non-carrier class backhauls to be near-carrier class backhauls by providing configurable base stations (e.g., picocells and/or femtocells) which are in communication with a network operations center and an ISP network. In one implementation, the network operations center monitors, isolates faults, and configures the picocells so that the non-carrier class backhaul connections provided by the ISP network connections to the picocells can be upgraded to near-carrier class backhauls. As described above, an external radio device support system (ERDSS) module in each picocell enables the network operations center to configure (or reconfigure) the picocells based on various parameters including demand, change in operating environment, future needs, etc. Additional implementations and variations are also within the scope of the invention. For example, the illustrated implementations discuss isolating, pinpointing faults, and reconfiguring the picocells when there are loss of connections. However, in other implementations, the picocells can be reconfigured even when the connections are not lost. For example, the picocells can be reconfigured to address the changing operating environment such as when the building in which the picocells are located is renovated or expanded to cover wider area or additional user devices. Additionally, in one embodiment the picocells have carrier class backhaul connections.

Those of skill will appreciate that the various illustrative logical blocks, modules, units, and algorithm steps described in connection with the embodiments disclosed herein can often be implemented as electronic hardware, computer software, or combinations of both. To clearly illustrate this interchangeability of hardware and software, various illustrative components, units, blocks, modules, and steps have been described above generally in terms of their functionality. Whether such functionality is implemented as hardware or software depends upon the particular system and design constraints imposed on the overall system. Skilled persons can implement the described functionality in varying ways for each particular system, but such implementation decisions should not be interpreted as causing a departure from the scope of the invention. In addition, the grouping of functions within a unit, module, block or step is for ease of description. Specific functions or steps can be moved from one unit, module or block without departing from the invention.

The various illustrative logical blocks, units, steps and modules described in connection with the embodiments disclosed herein can be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor can be a microprocessor, but in the alternative, the processor can be any processor, controller, microcontroller, or state machine. A processor can also be implemented as a combination of computing devices, for example, a combination of a DSP and a microprocessor, a plurality of microprocessors, one or more microprocessors in conjunction with a DSP core, or any other such configuration.

The steps of a method or algorithm and the processes of a block or module described in connection with the embodiments disclosed herein can be embodied directly in hardware, in a software module (or unit) executed by a processor, or in a combination of the two. A software module can reside in RAM memory, flash memory, ROM memory, EPROM memory, EEPROM memory, registers, hard disk, a removable disk, a CD-ROM, or any other form of machine or computer readable storage medium. An exemplary storage medium can be coupled to the processor such that the processor can read information from, and write information to, the storage medium. In the alternative, the storage medium can be integral to the processor. The processor and the storage medium can reside in an ASIC.

Various embodiments may also be implemented primarily in hardware using, for example, components such as application specific integrated circuits (“ASICs”), or field programmable gate arrays (“FPGAs”). Implementation of a hardware state machine capable of performing the functions described herein will also be apparent to those skilled in the relevant art. Various embodiments may also be implemented using a combination of both hardware and software.

The above description of the disclosed embodiments is provided to enable any person skilled in the art to make or use the invention. Various modifications to these embodiments will be readily apparent to those skilled in the art, and the generic principles described herein can be applied to other embodiments without departing from the spirit or scope of the invention. Thus, it is to be understood that the description and drawings presented herein represent a presently preferred embodiment of the invention and are therefore representative of the subject matter, which is broadly contemplated by the present invention. It is further understood that the scope of the present invention fully encompasses other embodiments that may become obvious to those skilled in the art.

1. A method of providing a near-carrier class service to a non-carrier class backhaul network, comprising:
monitoring a connection of the non-carrier class backhaul network of at least one picocell by periodically sending at least one message to a monitoring agent located within an internet service provider network;
tracing the connection to the monitoring agent through a network operations center when an acknowledgement in response to the at least one message is not received from the monitoring agent;
generating an alert message that provides detailed information about a point of failure in the connection when a loss of connection is detected in tracing the connection; and
generating a solution to fix the loss of connection so that the near-carrier class service can be provided to the non-carrier class backhaul network of the at least one picocell.

2. The method of claim 1, wherein the monitoring agent is located within a headend of the internet service provider network.

3. The method of claim 2, wherein the headend is a headend of a cable television network.

4. The method of claim 1, further comprising:
receiving instructions from the network operations center to remotely reconfigure at least one external radio device within a first picocell of the at least one picocell when the detailed information indicates that the point of failure is at the first picocell; and
reconfiguring the at least one external radio device within the first picocell according to the instructions.

5. The method of claim 4, wherein reconfiguring at least one external radio device comprises
configuring the at least one external radio device to operate using at least one of different frequencies and different protocols.

6. The method of claim 4, wherein remotely configuring at least one external radio device comprises
configuring the at least one external radio device to operate based on demand.

7. The method of claim 4, wherein remotely configuring at least one external radio device comprises
activating the at least one external radio device that was reserved for a future need when the detailed information about a point of failure indicates that an external radio device of the at least one external radio device has failed.

8. The method of claim 1, further comprising:
receiving instructions from the network operations center to remotely reconfigure at least one external radio device within a first picocell of the at least one picocell to adjust a coverage period of the at least one external radio device; and
reconfiguring the at least one external radio device within the first picocell according to the instructions.

9. The method of claim 1, wherein tracing the connection to the monitoring agent comprises
performing quality of service functions.

10. The method of claim 9, wherein the quality of service functions comprise
classifying, queuing, prioritizing, sending or dropping packets based on service level requirements.

11. A method, comprising:
receiving a connectivity alert message from at least one picocell providing detailed information about a point of failure in a connection for a backhaul network of the at least one picocell;
determining whether an acknowledgement in response to the connectivity message has been received from a monitoring agent located within an internet service provider network;
tracing the connection to the monitoring agent when the acknowledgement in response to the connectivity message has not been received from the monitoring agent;
generating a solution to fix a loss of connection due to a failure in the point of failure so that a near-carrier class service can be provided to the non-carrier class backhaul network of the at least one picocell.

12. The method of claim 11, further comprising
remotely reconfiguring at least one external radio device within a first picocell of the at least one picocell when the detailed information indicates that the point of failure is at the first picocell.

13. The method of claim 12, wherein remotely reconfiguring at least one external radio device comprises
configuring the at least one external radio device to operate using at least one of different frequencies and different protocols.

14. The method of claim 12, wherein remotely configuring at least one external radio device comprises
configuring the at least one external radio device to operate based on demand.

15. The method of claim 12, wherein remotely configuring at least one external radio device comprises
activating the at least one external radio device that was reserved for a future need when the detailed information about a point of failure indicates that an external radio device of the at least one external radio device has failed.

16. The method of claim 12, further comprising:
remotely reconfiguring at least one external radio device within a first picocell of the at least one picocell to adjust a coverage period of the at least one external radio device.

17. A system, comprising:
a controller to monitor a connection of a non-carrier class backhaul network of at least one picocell by periodically sending at least one message to a monitoring agent located within an internet service provider network, to trace the connection to the monitoring agent through a network operations center when an acknowledgement in response to the at least one message is not received from the monitoring agent, and to generate an alert message that provides detailed information about a point of failure in the connection when a loss of connection is detected in tracing the connection; and
a backhaul unit to generate a solution to fix the loss of connection so that a near-carrier class service can be provided to the non-carrier class backhaul network of the at least one picocell.

18. The system of claim 17, wherein the monitoring agent is located within a headend of the internet service provider network.

19. The system of claim 18, wherein the headend is a headend of a cable television network.

20. The system of claim 17, further comprising
a router to receive instructions from the network operations center to remotely reconfigure at least one external radio device within a first picocell of the at least one picocell when the detailed information indicates that the point of failure is at the first picocell, and to pass the instructions to the controller to reconfigure the at least one external radio device within the first picocell according to the instructions.
